(19) United States
(12) Patent Application Publication
(10) Pub. No.: US 2025/0301161 A1
(43) Pub. Date: Sep. 25, 2025

(54) ENCODING A BINARY IMAGE

(71) Applicant: Microsoft Technology Licensing, LLC, Redmond, WA (US)

(72) Inventors: Christian VOSS-WOLFF, Herzberg am Harz (DE); Benjamin Markus THAUT, Eningen unter Achalm (DE); Thomas Markus KEINZ, Pfullingen (DE)

(21) Appl. No.: 18/614,628

(22) Filed: Mar. 22, 2024

(51) Int. Cl. H04N 19/436; H04N 19/136; H04N 19/17; H04N 19/91; H04N 19/93

(52) U.S. Cl. CPC H04N 19/436; H04N 19/136; H04N 19/17; H04N 19/91; H04N 19/93

(57) ABSTRACT

In various examples there is a method for encoding a binary image, the method comprising receiving the binary image; performing run-length encoding on pixel data of the binary image to produce run-length encoded data; performing differential encoding on the run-length encoded data to produce differential encoded data; performing variable length encoding on the differential encoded data to produce variable length encoded data; and applying a lossless compressor to the variable length encoded data to produce compressed data, the compressed data being an encoded binary image.

### BACKGROUND

Binary images are used in a wide variety of situations, including as cutout masks to produce image compositions, in various examples by masking an exact outline of objects in a video stream. For accuracy, such masks are typically used at a multiple of the resolution of color and depth images used for display.

In head mounted devices (HMDs), especially where cutout masks are used to produce compositions based on tracked movements of a user, it is challenging to ensure that the composition and therefore generation and use of the cutout masks is fast, reducing latency. For usability, it is challenging to be able to generate and/or use a cutout mask in the order of a millisecond or less of compute time. Additionally, it is challenging to use high-resolution masks (at resolutions higher than color and depth images used for display), which ensures accuracy.

Typically, a remote rendering system generates a cutout mask using a powerful remote renderer, and sends via a network the cutout mask to a less-powerful HMD for use. For high resolutions, sending cutout masks requires high network bandwidths, likely exceeding 1 Gbps. Various approaches use different compression techniques to reduce the required bandwidth. However, achieving the desired low-bandwidth whilst maintaining the quality of the cutout mask and achieving decompression and compression in the order of a millisecond or less of compute time is difficult.

The embodiments described below are not limited to implementations which solve any or all of the disadvantages of known encoding and/or decoding technology.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A combination of encoding/decoding techniques are applied to a binary image; run-length encoding/decoding, differential encoding/decoding, variable length encoding/decoding, and a lossless compressor/decompressor. In this way, accurately decodable high-resolution binary images are losslessly encodable/decodable. In particular, this is advantageous for encoding cutout masks for use in compositing images for mixed reality systems.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a remote computer comprising an encoder in communication with a local computer comprising a decoder via a network;

FIG. 2 shows an exemplary binary image;

FIG. 3 is a flow chart of a method of encoding a binary image;

FIG. 4 shows exemplary pixel data of a binary image;

FIG. 5 shows exemplary data after run-length encoding;

FIG. 6 shows exemplary data after differential encoding;

FIG. 7 is a flow chart of a method of decoding an encoded binary image; and

FIG. 8 illustrates an exemplary computing-based device in which embodiments of an encoder and/or decoder are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

Although the present examples are described and illustrated herein as being implemented in a binary image processing system, the system described is provided as an example and not a limitation. As those skilled in the art will appreciate, the present examples are suitable for application in a variety of different types of data processing systems.

As explained above, binary images, which are images comprising pixel data, each pixel having one of two possible values, in an example 0 and 1, are applied in a wide variety of situations. In some cases, a binary image is used as a mask. A mask in this sense is data that defines at least one area, in some examples used to hide and/or reveal the defined area during further processing. A cutout mask is a mask used to at least hide a defined area. In various examples, the defined area corresponds to an area of an image, for example a color and/or depth image. For improved accuracy compared with a smaller resolution, a mask is typically used at a multiple of the resolution of a corresponding image. Accuracy, for example, refers to how closely a mask defines an area depicting an object relative to the object's actual area in an image corresponding to the mask.

In low-powered computing devices, especially in a head-mounted device (HMD), which in some examples tracks movements of a user and/or receives video of an environment for example that is moving, it is difficult to generate binary images such as masks quickly and with a high resolution, due to the lower computing power relative to, for example, a non-head-mounted device. It is often desirable in these contexts to use masks with a resolution of 1000×1000 pixels to 8000×8000 pixels. An approach therefore offloads the generation of the binary images to a higher-powered computing device, sending the generated binary image once complete to the low-powered computing device, in an example in or associated with an HMD. In the case of a mixed reality system enabled by an HMD, binary images corresponding to masks are in various examples used frame-by-frame to compose a video, therefore a rate of binary images consistent with at least a framerate of a video displayed by a display of the HMD are desired to be received.

However, it is difficult to generate a binary image with a high resolution (enabling accurate reflection of, for example, a real-world object) yet that can be consistently transferred in a sequence of binary images to a device via a network, given that high resolution images require more bandwidth than lower resolution images.

Various approaches using codecs can compress to a degree binary images, lowering the bandwidth required for transmission. However, especially for binary images generated from received data and/or those used for frame-by-frame composition, it is desirable to compress on the high-powered computing device and decompress on the low-powered computing device quickly enough to be useful.

The inventors have noted that, to become usable in practice, a compression ratio that reduces the bandwidth required for sending images to approximately 10 Mbps or less is desired. The inventors have therefore noted that a lossless compression ratio of at least 100:1, combined with a computational time of the order of one millisecond for compression and decompression is desirable, especially for use in mixed reality and/or HMD systems.

An approach using a WebP codec may achieve the desired compression ratio but requires multiple milliseconds of computational time using a hardware video encoding engine.

An approach using a general purpose codec such as LZMA or zSTD enable the desired computational speed, but do not enable the desired compression ratio.

The inventors have noted that using masks to produce composite images improves upon chroma keying approaches by achieving composition without artifacts such as color bleeding, therefore that improving mask compression to enable high-speed, high-compression ratios is desirable.

The inventors have found that it is possible to exploit properties of a binary image and therefore achieve the desired compression ratios and computational speeds by performing multiple passes using different encoding techniques on the binary image and subsequent data, namely run-length encoding, differential encoding, variable length encoding, and lossless compression.

Namely, an apparatus comprising a processor and a memory storing instructions that, when executed by the processor, perform a method for encoding a binary image is described. The method comprises receiving the binary image and performing run-length encoding on one of: at least two rows and at least two columns, of pixels in the binary image to produce run-length encoded data. Run-length encoding is an unconventionally useful first step that compresses the binary image data and prepares the data for the following passes, given a prediction that a pixel's value in a binary image matches the pixel to the left of it a majority of the time, in which case each row or column of the binary image can be replaced with a small number of runs relative to the number of pixels.

Subsequently, the method comprises producing differential encoded data by performing differential encoding on the run-length encoded data. This is particularly advantageous in allowing subsequent encoding to achieve a higher compression ratio. Especially, in the case of masks for HMDs, masks for mixed reality systems and/or cutout masks, this makes use of a prediction that runs are correlated in an arithmetic progression in the sense that a row will often cross through a same object as another row either at the same position or offset by a constant amount. These arithmetic progressions are replaced by exactly repeating patterns, allowing more effective compression by a lossless compressor and revealing structure in the encoded binary image, described below. Additionally, differential encoding reduces the numerical size of the values, allowing more effective compression by variable length encoding, as described below.

Subsequently, the method comprises performing variable length encoding on the differential encoded data to produce variable length encoded data. This, in an efficient and parallelizable way, further reduces the number of bytes representing the same information, increasing the compression ratio of the method.

Finally, the method comprises applying a lossless compressor to the variable length encoded data to produce compressed data, the compressed data being an encoded binary image. This, due to the revealed structure of the binary image in the prior passes, revealing repeating patterns, provides an additional factor to the compression ratio of the method.

The method, comprising an unconventional combination of encoding techniques, therefore enables lossless compression with a high compression ratio (in excess of 100:1), whilst maintaining encoding computational speed (of the order of 1 millisecond).

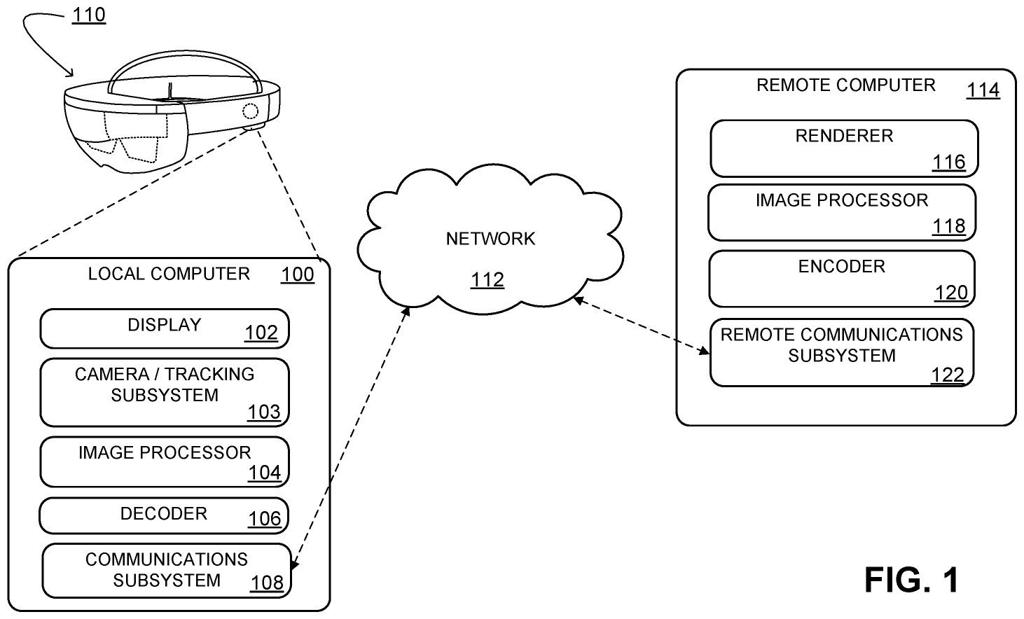

FIG. 1 is a schematic diagram of a remote computer comprising an encoder in communication with a local computer comprising a decoder via a network. It shows an exemplary environment in which the disclosed invention is implemented. In various examples, functionality implementing the disclosed invention are located in and/or performed by local computer 100 and/or remote computer 114. Local computer 100 in some examples is comprised in and/or associated with a head-mounted device 110.

Local computer 100 comprises a display 102, camera or tracking subsystem 103, image processor 104, decoder 106, and communications subsystem 108, or any combination including a decoder 106 thereof. Communications subsystem 108, in an example, communicates via a network 112, and receives an encoded binary image. A decoder 106, in an example, decodes the encoded binary image to produce a binary image. Image processor 104, in an example, uses the binary image to compose an image. In various examples, composing (also referred to as compositing) an image comprises overlaying an image onto another image, using the binary image to define areas of the image to replace with areas of the other image during composition.

Local computer 100 optionally comprises a camera and/or tracking subsystem 103. In an example, the subsystem 103 tracks the movements of at least one of: a user of a head-mounted device 110 and an object, producing movement data. For example, movement data comprises data indicating a position of at least one of: a user, a portion of the user, an object. Subsystem 103 optionally uses a camera to track the movements. Subsystem 103 optionally does not comprise a camera and instead receives an image. In various examples, subsystem 103 provides movement data to the image processor 104, for use in composing an image. In an example, subsystem 103 comprises a camera and takes images of an environment in which a head-mounted device 110 is located.

In one case, local computer 100 comprises a display 102. Display 102 optionally displays one or more of: images produced by the image processor 104, images decoded by the decoder 106, images received by the communications subsystem 108.

In some cases, decoder 106 is implemented as a hardware decoder on the local computer 100. In other cases, decoder 106 is implemented in software or firmware. In an example, decoder 106 is used for binary image decoding, and local computer 100 comprises an additional decoder used for decoding other images, for example including depth and/or color images. In one example, the additional decoder is a hardware decoder and the decoder 106 is a software decoder.

Remote computer 114 comprises a renderer 116, image processor 118, encoder 120, and remote communications subsystem 122, or any combination including encoder 120 thereof.

Renderer 116 is optionally used to render an image for displaying at least a portion of the rendered image on the display 102 of a local computer 100. Rendering refers to the generation of an image, for example a binary image. In some examples, remote computer 114 comprises an additional renderer to the renderer 116. In an example, renderer 116 is used to generate binary images, and the additional renderer is used to generate color and/or depth images.

In various examples, renderer 116 receives movement data generated by a camera and/or tracking subsystem 103 on a local computer 100. It should be appreciated that different rendering methods are used by the renderer 116, and that rendering in different cases is based on a variety of input data, for example movement data generated by a camera and/or tracking subsystem 103 on a local computer 100. In various examples, rendering an image comprises generating a binary image, for example a cutout mask. In some cases, the cutout mask is received from a game application executing on the remote computer 114. In some cases, the cutout mask is computed by segmenting an image. The cutout mask is obtained, in some cases, by marking each of at least one pixel, for example by defining a value associated with a pixel of a binary image, with a first or second value, in an example a 0 or 1, derived from a corresponding pixel value of a color and/or depth image received by the application prior to any modification of the color and/or depth image. In various examples, the first or second value is derived from the corresponding pixel value prior to an adjustment that reduces quality of the color and/or depth image, in some examples to prepare the color and/or depth image for network transmission. In some cases, the adjustment is one or more of: downscaling and lossy video encoding. In one case, a cutout mask is derived from a value of an alpha channel of a color image, with a first and second value, for example 0 and 1, marking transparent and respectively opaque regions. In one case, a cutout mask is derived from a depth image, with a first and second value, for example 0 and 1, marking regions that are far and close respectively, to a defined threshold.

In various examples, remote computer 114 has more computational power than local computer 100, enabling remote computer 114 to render images more quickly than local computer 100.

Image processor 118, in some examples, receives a rendered image by the renderer 116 and performs processing on the rendered image, in an example transforming the rendered image. An image comprises pixel data, in one case at least one value associated with a pixel of the image. In an example, transforming the rendered image comprises altering pixel data of the rendered image. In some examples, image processor 118 receives an image and produces an altered image. For example, image processor 118 receives an image from local computer 100, in some examples taken by a camera of the camera and/or tracking subsystem 103. In an example, the altered image is an image with a ray pointing from a detected hand or other entity, for example a controller. In various examples, detection is performed using a machine learning model.

Encoder 120 receives at least one of: a rendered image by the renderer 116 and a processed image by the image processor 118, and encodes the received image. Encoding, in various examples, comprises compressing the received image such that less data is required to represent the image. Compression is lossless or lossy, though encoding via the disclosed technology is lossless. By encoding the image and therefore reducing the data required to represent the image, the disclosed technology uses less memory to store the compressed image than in alternate approaches. By compressing losslessly, the disclosed technology enables faster computational time without sacrificing quality of a resulting image as compared to alternate approaches, thereby producing an improved digital image.

Remote communications subsystem 122 facilitates communication with a network 112. In an example, an encoded image by the encoder 120 is sent via network 112, for example using the remote communications subsystem 122, to local computer 100, where in an example communications subsystem 108 receives the encoded image.

In various examples, the image rendered by the renderer 116 is a binary image. As described herein, a binary image is for example a cutout mask. In some examples, the cutout mask is derived from a color and/or depth image. In some examples, the cutout mask is for representing boundaries of regions in an image which would be encumbered with errors through a lossy encoding process performed on the image. In this way, the cutout mask later enables the recovery of accurate boundaries of regions, for example entities within the image, after decoding.

Renderer 116 optionally receives at least one of: an image generated by the camera and/or tracking subsystem 103 and movement data generated by the camera and/or tracking subsystem 103, and generates a binary image based on at least one of: an object, at least a portion of a user, and a region, identified within the received data. The renderer 116 optionally receives data from local computer 100 via network 112, i.e. in some examples via the use of communications subsystem 108 and remote communications subsystem 122.

In various examples, the generated binary image is a cutout mask that indicates a region corresponding to at least one of: an object, an entity, a type of entity, and at least a portion of a user. Indication of a region refers, for example, to values associated with pixels associated with the region being a first value, whilst, for example, values associated with pixels outside of a region are a second value. In some examples, multiple regions are indicated by a single binary image.

In various examples, the generated binary image is encoded by encoder 120 and an encoded image is sent to a device, for example local computer 100, and in some examples via remote communications subsystem 122. Local computer 100 optionally receives, for example via communications subsystem 108, an encoded binary image, for example the encoded binary image sent via remote communications subsystem 122.

It should be appreciated that any number of images are in various examples generated, received and/or sent by the mentioned components.

In some examples, decoder 106 decodes the received encoded binary image, in an example a cutout mask, and the local computer 100 uses the decoded binary image to perform, via image processor 104, at least one of: overlay a received image taken by a camera onto a received rendered image for display, overlay a received rendered image onto a received image taken by a camera for display, overlay a first image onto a second image, and remove at least a portion of an image.

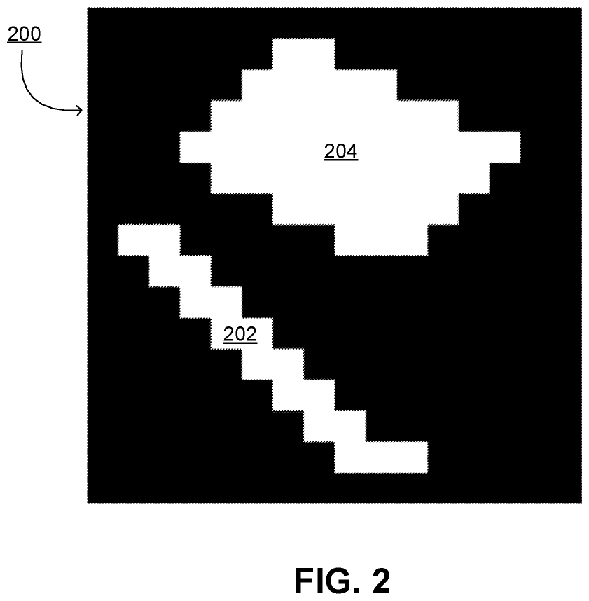

FIG. 2 shows an exemplary binary image, for example a cutout mask. Image 200 is a representation of the pixel values of a binary image, having two possible pixel values. Regions 204 and 202 represent pixels with a first value as being white. Black squares represent pixels with a second value that is different to the first value.

In an example, region 204 corresponds to a screen in an image of an environment. A corresponding color image would show the screen at the same pixel locations as indicated by the region 204. In an example, region 202 represents an edge of an entity, for example a ray pointing from a controller held by a user or from a user's hand. In an example, the ray is generated by an image processor such as processor 104 or processor 118.

It should be appreciated that image 200 is merely exemplary of an situation typical of mixed-reality or head-mounted device systems, and that in various examples, the disclosed invention is applied to other images and contexts. In particular, images taken in mixed-reality and/or head-mounted device contexts differ from other types of binary images such as in scanned document contexts in that the target resolution is typically higher than that desired for scanned documents, and there are polygonal geometric features of a 3D model from which images are rendered, as opposed to the repetitive structure of, for example, letters in a scanned document.

Image 200 in an example is used by an image processor, such as image processor 104 of FIG. 1, to compose an image. In an example, the regions 204 and 202 in image 200 are used by the image processor when overlaying at least a first and second image by keeping regions of the first image corresponding to regions 204 and 202 of image 200, where image 200 represents a mask associated with the first image, visible in the overlaid image, and allowing at least a portion of the second image to be visible in the overlaid image where the portion of the second image corresponds to regions of image 200 outside of the indicated regions 204 and 202.

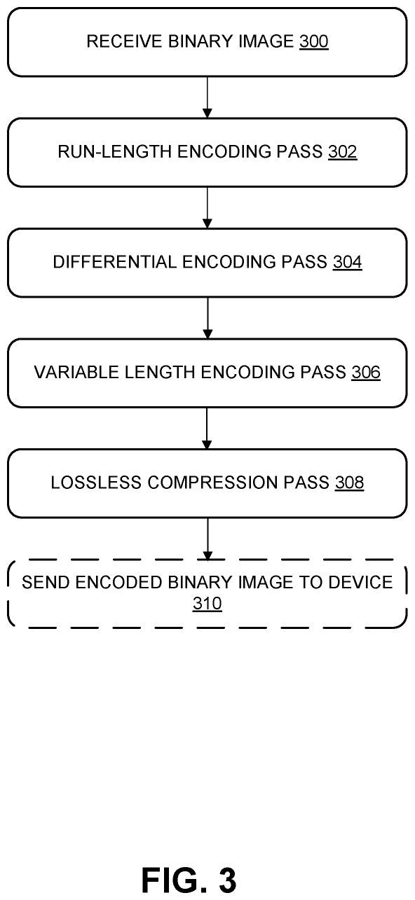

FIG. 3 is a flow chart of a method of encoding a binary image, in various examples performed by a device remote computer 114 using encoder 120 of FIG. 1.

The method comprises receiving a binary image 300. In various examples the binary image is received from a renderer, another device, and/or a same device as the device performing the method. In some examples the binary image is accessed, for example from a memory.

The method further comprises a sequence of passes 302-308, each pass applying an encoding technique. Firstly, a run-length encoding pass 302 is applied to the received binary image. Applying an encoding pass to an image refers to performing the relevant encoding on data of the image, for example pixel data referring to at least one value associated with a pixel of the image. Run-length encoded data is produced by the run-length encoding pass 302.

Subsequently, a differential encoding pass 304 is performed on the run-length encoded data produced by the run-length encoding pass 302. Passes 302 and 304 are elaborated upon below. Differential encoded data is produced by the differential encoding pass 304.

Subsequently, a variable length encoding pass 306 is performed on the differential encoded data produced by the differential encoding pass 304. Performing a variable length encoding pass 306 refers to performing variable length encoding on input data. Variable length encoded data is produced by the variable length encoding of the variable length encoding pass 306.

The variable length encoding is in some cases performed on each value of the differential encoded data. In various examples, the variable length encoding is performed on at least one value of the differential encoded data. In an example, the format of values of the differential encoded data is one of: Unicode characters, numbers, binary representations of numbers. In some examples, the format of values of the differential encoded data is transformed into a different format to enable the variable length encoding.

In various examples, the variable length encoding is performed on at least two values of the differential encoded data in parallel. In this way, computing time for the variable length encoding pass 306 is reduced.

In various examples, the variable length encoding is byte-wise variable length encoding. Variable length encoding is a type of compression that encodes numerical values under the assumption that smaller numbers occur more frequently than larger numbers, by using fewer bytes to represent smaller numbers than used to represent larger numbers. In some cases, variable length encoding uses at least one bit to indicate how many bytes represent a number in a stream of bits.

As a first example, to illustrate the general concept behind variable length encoding, consider that a number is represented in binary using a sequence of bytes, each of 8 bits (each bit having a value of either 1 or 0). A binary number 01000001 indicating 65 using one byte and a binary number 01000001 00100100 indicating 16676 using two bytes would, without variable length encoding, both be represented as 00000000 10000001 for 65, and 01000001 00100100 for 16676. This ensures that, upon receiving a stream of bytes, it is known that every two bytes represents a value, therefore enabling reconstruction of the represented values.

In an exemplary variable length encoding technique, 65 is encoded as 01000001, and 16676 as 11000001 00100100, where the first bit on each byte indicates whether, in the case of a 0, the current byte is the last of a number, or, in the case of a 1, the current byte is not the last byte of a number. In this way, the numbers 65 and 16676 can be encoded in a stream of bits as 01000001 11000001 00100100, which uses 8 less bits than representing the same numbers in a stream of bits without variable length encoding as 00000000 10000001 01000001 00100100. Therefore, the total storage required for representing the input data to a variable length encoding pass 306 is reduced.

In various examples, GroupVarint Encoding is used as the variable length encoding. This allows highly efficient, parallelizable encoding and decoding, compared to, say, UTF-8 encoding, which sequentially encodes each Unicode code point into a binary representation using between 1-6 inclusive bytes and is slower. GroupVarint Encoding uses a single byte as a header for four variable-length values, the header comprising four two-bit numbers representing how many bytes for each of the headed values are used to represent the value.

Subsequently, a lossless compression pass 308 is performed on the variable length encoded data produced by the variable length encoding pass 306. Performing a lossless compression pass 308 refers to performing lossless compression on input data. Compressed data is produced by the lossless compression of the lossless compression pass 308.

In various examples, the lossless compression is performed using a lossless compressor, in an example one of: a dictionary compressor and an entropy compressor. The lossless compressor is, for example, a general-purpose lossless compressor, for example one of: a zSTD and an LZMA compressor.

A lossless compressor reduces the storage requirement to represent values in a way that no information is lost when data compressed by the lossless compressor is decompressed and the original values attempted to be reconstructed.

A dictionary compressor is a compressor that uses a technique wherein repeating patterns within data are each replaced by a single value alongside a definition which associates the single value with the replaced pattern. As an example, to illustrate the technique, patterns of values being 100100010101100 can be replaced by 110001, with a definition being 1 mapped to 100 and 0 mapped to 01. In this way, the values that are needed for representation are 110001 (6 bits), 1 100 (4 bits), and 0 01 (3 bits), providing a total of 13 bits, which is less than the 15 bits required for the original 100100010101100 values. Whilst this example is simple, a dictionary compressor uses this underlying concept.

An entropy compressor, in one example, is a compressor using Huffman coding, which uses a similar concept to a dictionary compressor, but replaces data that occurs more frequently with less bits than data that occurs more frequently, storing the mappings between replaced values and their replacement. An entropy compressor, in an alternate example, is a compressor using arithmetic coding.

Because the prior differential encoding pass 304, as elaborated on below, attempts to reveal repeating sequences of values, lossless compression, for example by a general-purpose lossless compressor, is more effective than if the repeating sequences of values had not been revealed. As such, an additional compression ratio, in some cases being 2:1 for the lossless compression pass 308, enables a high overall compression ratio of, in some cases, at least 100:1.

The compressed data produced by the lossless compression pass 308 is an encoded binary image, which, is optionally sent to a device 310. In various examples, a device to which the encoded binary image is sent is the local computer 100 of FIG. 1. In one example, the sending of the encoded binary image to a device 310 is for decoding.

In various examples, metadata indicating a resolution of the binary image received 300 and encoded is sent to the device alongside the sending of the encoded binary image to the device 310. This enables the decoding of the encoded binary image by the receiving device. In some cases, a resolution of the binary image received 300 is known in advance or otherwise determined by the device that receives the encoded binary image that is sent by the method.

The passes 302-308 in various examples are performed entirely using software, and therefore do not use hardware encoding resources that for example are used for encoding color and/or depth images. In other examples, the passes 302-308 are implemented at least in part using hardware logic and/or firmware.

Run-length encoding pass 302 will now be elaborated upon.

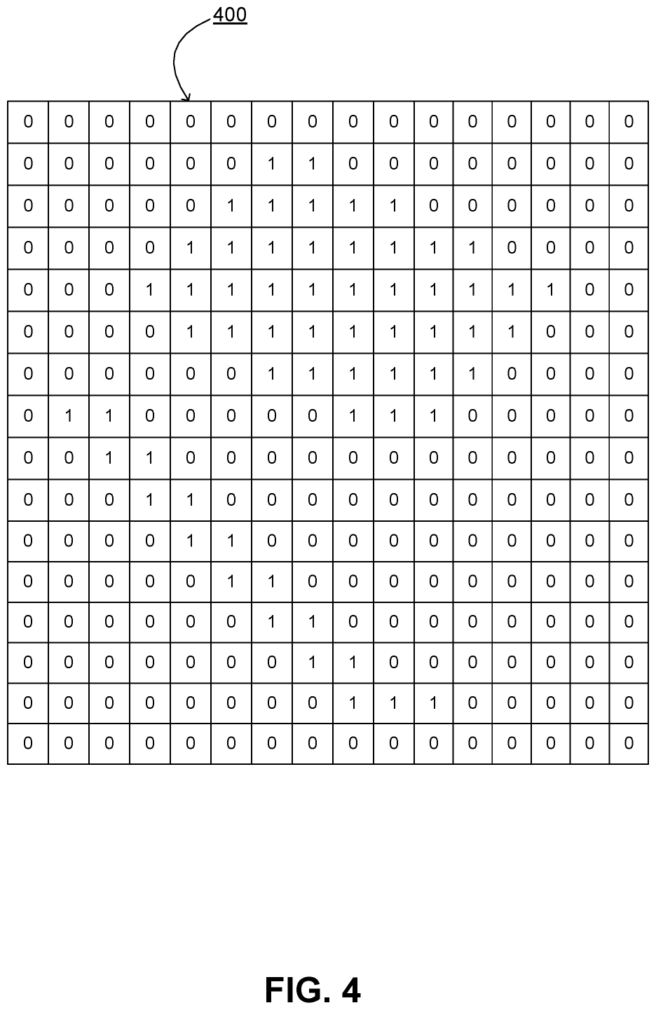

FIG. 4 shows exemplary pixel data of a binary image, for example the binary image received 300 in the method of FIG. 3. The values of the binary image data 400 are each associated with a pixel. In some cases, the pixels of the binary image data 400 correspond to the pixels of an image, in an example one of: a binary image, a color image, and a depth image. In various examples, the binary image data 400 is a binary image that is a mask for a second image, for example a cutout mask.

Illustratively, binary image data 400 reflects the underlying data of the representation of a binary image 200 in FIG. 2.

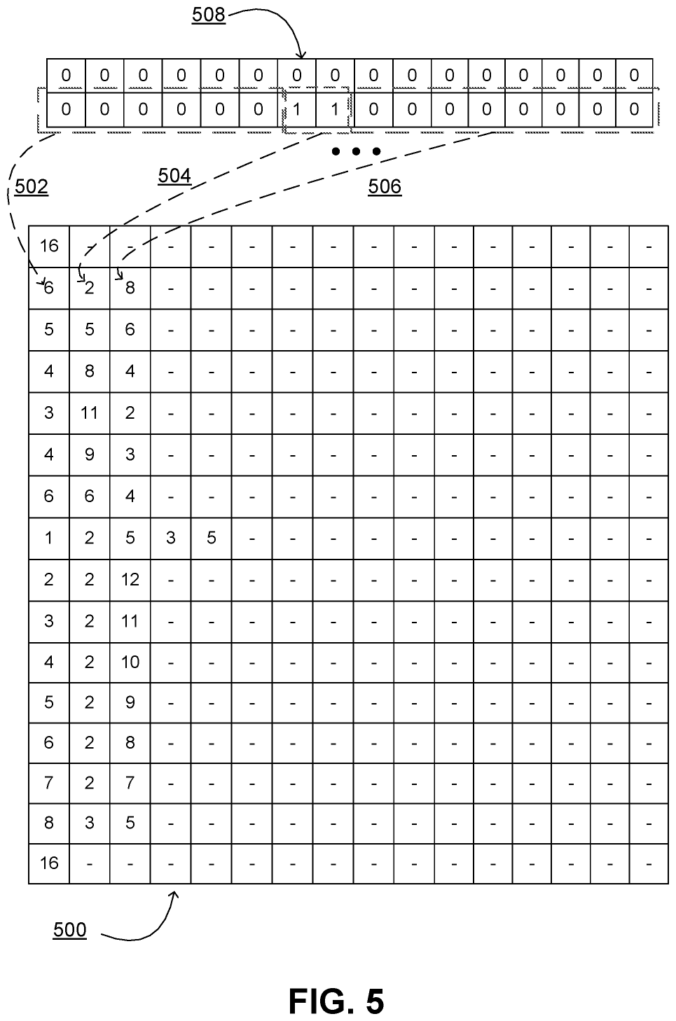

FIG. 5 shows exemplary data after run-length encoding, alongside an illustration of the process behind the run-length encoding pass 302 of FIG. 3.

Binary image data 508 reflects a portion of the binary image data 400 of FIG. 4; the first two rows. Run-length encoded data 500 illustrates run-length encoded data after run-length encoding has been performed on the binary image data 400 of FIG. 4.

Run-length encoding comprises recording runs of pixels, summing the number of pixels in the binary data 400 of FIG. 4 with consecutive same values. Where a value changes in a subsequent pixel, the sum inclusive of the last pixel with the same value is recorded, and the sum restarts.

For illustration, binary image data 400 of FIG. 4 comprises 16 pixels with a value of 0 in the first row, so the run-length encoding pass 302 of FIG. 3, when a run-length encoding process is performed, determines a value of 16 and stores this value. In the second row, binary image data 400 of FIG. 4, represented by the second row of binary image data 508, comprises 6 pixels with a value of 0, followed by 2 pixels with a value of 1, followed by 8 pixels with a value of 0. As such, the run-length encoding process determines respectively 502, 504, 506 values of 6, 2, 8, and stores these values.

Whilst run-length encoded data 500 is illustrated in a matrix form, it should be understood that any suitable form of storing data throughout the encoding process is possible, including, for example, storing data in an array, a matrix, and/or a stream of values. In an example where a first matrix storing the values of the binary image data received 300 by the encoding process is used, the run-length encoding of the values of the binary image data produces, in various examples, a second matrix with run-length encoded values as mentioned above, and where unused indices of the second matrix are uninitialized. Uninitialized matrix indices are represented by hyphens in FIG. 5.

It should also be noted that, though FIG. 5 illustrates run-length encoding by row, in various examples run-length encoding is performed per-column instead. Additionally, in some cases, the illustrated method of run-length encoding a row of binary image data is repeated.

In an example, each row or column of the binary image data received 300 in the method of FIG. 3 is, in one example independently, run-length encoded. In various examples, at least two rows or at least two columns of the binary image data received 300 in the method of FIG. 3 are, in one example independently, run-length encoded. In various examples, at least two rows or at least two columns are, in one example independently, run-length encoded in parallel with each other.

After the run-length encoding pass 302 of FIG. 3 is complete, run-length encoded data 500 is produced.

Differential encoding pass 304 of FIG. 3 will now be elaborated upon.

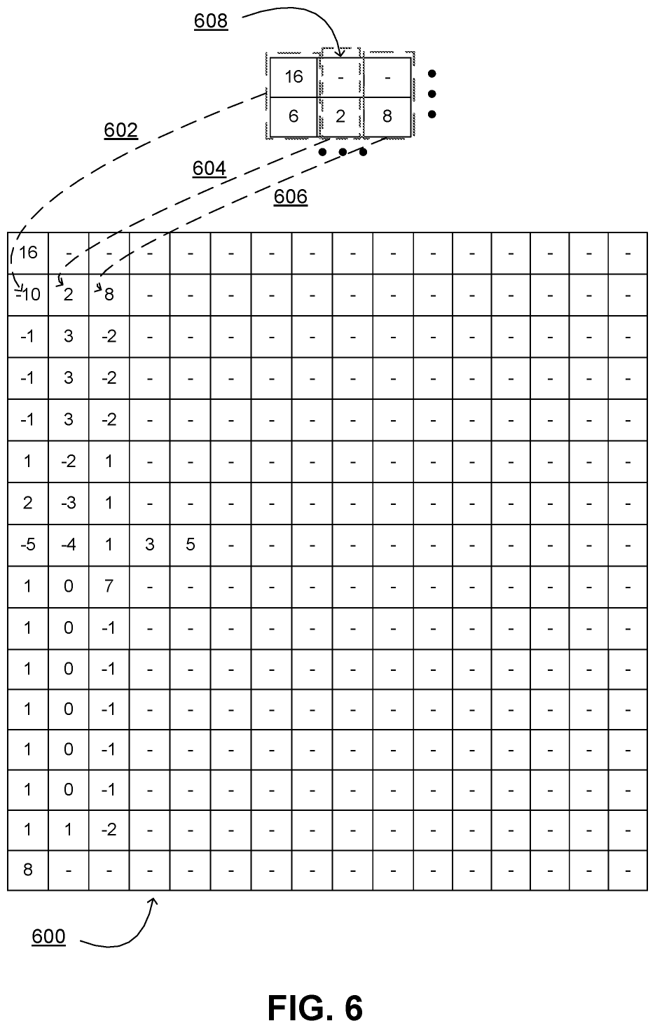

FIG. 6 shows exemplary data after differential encoding, alongside an illustration of the process behind the differential encoding pass 304 of FIG. 3.

Run-length encoded data 608 reflects a portion of the run-length encoded data 500 of FIG. 5; the first two rows, and first three columns respectively. Differential encoded data 600 illustrates differential encoded data after differential encoding has been performed on the run-length encoded data 500 of FIG. 5.

Differential encoding comprises subtracting, from a first value in run-length encoded data, a second value in the run-length encoded data, where a second value exists. The second value is located in a first sequence of values, in some examples all values, in the run-length encoded data associated with a row or column of pixels of a binary image that is different to a row or column of the pixels with which the first value is associated. In an example, the second value and the first sequence of values are associated with a same row or column of pixels of the binary image. The second value is located at a position in the first sequence corresponding to a position of the value in a second sequence of values, in some examples all values, in the run-length encoded data associated with a row or column of the pixels with which the value is associated. In an example, the value and the second sequence of values are associated with a same row or column of pixels of the binary image. In various examples, the first and the second sequences of values correspond to a row or column of pixels of the binary image. In one case, whether a different row or different column is chosen for the differential encoding is based on the choice of how run-length encoding was performed. In some cases, if run-length encoding was performed per-row, differential encoding is also performed per row. In some cases, if run-length encoding was performed per-column, differential encoding is also performed per column.

In various examples, a corresponding position in a sequence of values refers to having the same index in the sequence, for example a same position in an order of values of the sequence.

In an example, the first sequence of values in the run-length encoded data is associated with a row or column of pixels of a binary image that is one of: immediately prior and prior, to a row or column of the pixels with which the first value is associated.

In an example, the first sequence of values in the run-length encoded data is associated with a row or column of pixels of a binary image that is one of: immediately after and after, a row or column of the pixels with which the first value is associated. In various examples, after and prior with respect to rows or columns of pixels in the binary image correspond to differences in a row or column position of 1, 2, 3, 5, 10 or any other number of rows.

In various examples, being located prior and after to a row or column of the pixels refers to pixels of the binary image as they are indexed, in one example starting from an upper-left pixel of the binary image and continuing to a lower-right pixel of the binary image. In this example, a pixel in a row further to the top of an image and in a column further to the left of an image would be prior to a pixel further to the bottom and right of the image. It should be appreciated that many forms of indexing and representing the pixels of a binary image are possible.

In some cases, a second value existing refers to there being a value located at the position of the second value as defined. In an example, in response to a second value not existing, the first value is stored as the result of the differential encoding.

In some cases, the resulting value of the subtraction, from the first value, of the second value during differential encoding replaces one of: the first value and the second value, in the run-length encoded data to produce differential encoded data.

In various examples, the resulting value of the subtraction, from the first value, of the second value during differential encoding is stored in a location in a sequence of values that corresponds to the location of one of: the first value and the second value, in the run-length encoded data, to produce differential encoded data.

In some cases, differential encoding is performed for at least one value of the run-length encoded data. In some cases, differential encoding is performed for each value of the run-length encoded data.

For illustration, run-length encoded data 500 of FIG. 5 comprises a single value of 16 in the first row, so the differential encoding pass 304 of FIG. 3, when a differential encoding process is performed, determines a value of 16 and stores this value. In this illustrative example, differential encoding is performed by subtracting, from a first value in run-length encoded data, a second value in the run-length encoded data, where a second value exists, the second value located in a row that is immediately prior to a row with which the first value is associated. The result of the subtraction is stored in a location within the differential encoded data 600 corresponding to the location of the first value in the run-length encoded data 500 of FIG. 5. As such, as the first value has no prior row, a second value as defined does not exist, so the value is stored.

In the second row, run-length encoded data 500 of FIG. 5, represented by the second row of run-length encoded data 608, comprises values of 6, 2 and 8 respectively. As such, the differential encoding process determines respectively 602, 604, 606 values of −10, 2, 8, and stores these values. Determination 604 and 606 simply stores the run-length encoded values 2 and 8 respectively, as run-length encoded data 608, in this example, has no value in the prior row at a corresponding position. Differential encoded data 600 shows a result of performing differential encoding on each value of the run-length encoded data 500 of FIG. 5.

Whilst differential encoded data 600 is illustrated in a matrix form, it should be understood that any suitable form of storing data throughout the encoding process is possible, including, for example, storing data in an array, a matrix, and/or a stream of values. Differential encoded data 600 illustratively is structured as a matrix with the same dimensions as the matrix of run-length encoded data 500 of FIG. 5, with hyphens representing uninitialized values of the matrix.

In various examples, at least two values of the run-length encoded data upon which differential encoding is performed are differential encoded in parallel with each other.

Though differential encoding does not change the overall amount of data relative to the run-length encoding pass 302 of FIG. 3, differential encoding allows the subsequent encoding passes of FIG. 3 to compress the binary image to a greater degree. It is predicted that, in binary images and especially cutout masks, in various examples in head-mounted device and/or mixed reality contexts, runs of the run-length encoded data are typically correlated in an arithmetic progression.

In an example, if a row of pixels in an image of an environment crosses an object, such as a screen, it is predicted that the following row of pixels will cross through the same object, at either corresponding positions or offset by a constant amount. For objects bound by long line segments, this prediction generally holds. A binary image of the environment therefore in various examples comprises an arithmetic progression of pixels which is expressed when the binary image is run-length encoded.

By differential encoding the run-length encoded binary image, firstly, the numerical values of the run-length encoded data become smaller, enabling more effective compression (with a higher compression ratio) of the variable length encoding pass 306 of FIG. 3.

Secondly, differential encoding replaces arithmetic progressions in the run-length encoded data with exactly repeating patterns, enabling more effective compression by a lossless compression pass 308 of FIG. 3.

After the differential encoding pass 304 of FIG. 3 is complete, differential encoded data 600 is produced.

The disclosed method of encoding enables high compression ratios and fast compute time, and is especially applicable to enable the use of high-resolution cutout masks for composing images for display on a head-mounted device. A corresponding decoding method to the disclosed encoding method enables the decoding and use of the encoded binary image produced by the method of FIG. 3.

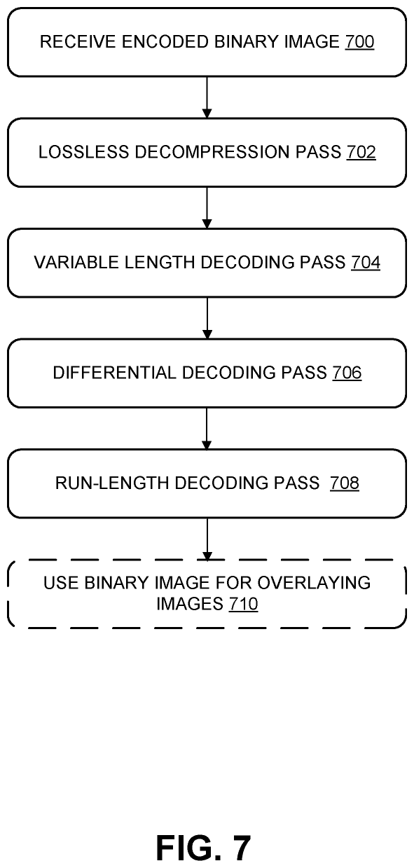

FIG. 7 is a flow chart of a method of decoding an encoded binary image. In an example, the encoded binary image is an image encoded by the method of FIG. 3. In some cases, the binary image that is sent 310 to a device in the method of FIG. 3 is received 700 by the method of FIG. 7. In some cases, the device to which the binary image is sent 310 in the method of FIG. 3 is a device implementing the method of FIG. 7.

After receiving an encoded binary image 700, the decoding method performs the reverse of the encoding method of FIG. 3. Namely, a lossless decompression pass 702, a variable length decoding pass 704, a differential decoding pass 706, and a run-length decoding pass 708 are performed.

A resulting binary image is optionally used 710 for overlaying images. In one example, the resulting binary image is a cutout mask indicating an area of a real-world entity depicted in an image, for producing an image composition for displaying on a head-mounted device.

In an example, the method of FIG. 7 further comprises using the resulting binary image, for example a cutout mask, to perform at least one of: overlay a received image taken by a camera onto a received rendered image for display, overlay a received rendered image onto a received image taken by a camera for display, overlay a first image onto a second image, remove at least a portion of an image.

Each of the respective decoding passes 702-708 will now be elaborated on.

Firstly, the encoded binary image that is received 700 comprises encoded data. Lossless decompression pass 702 comprises performing lossless decompression on the encoded data to produce decompressed data.

In various examples, the lossless decompression is performed using a lossless decompressor, for example one of: a dictionary decompressor and an entropy decompressor. In some cases, the lossless decompressor is a general-purpose lossless decompressor, for example one of: a Zstandard (zSTD) and a Lempel-Ziv-Markov Chain (LZMA) decompressor. In various examples, a corresponding decompressor to the compressor used in the lossless compression pass 308 of FIG. 3 i.e. the method used to encode the received binary image is used.

Lossless decompression reconstructs data provided to a lossless compressor when encoding the data, by replacing compressed bits of the data with decompressed i.e. original bits. In some cases, decompression requires additional data to the compressed data, which is received from and respectively sent by the encoding method of FIG. 3 alongside the encoded binary image.

Secondly, a variable length decoding pass 704 is performed on the decompressed data produced by the lossless decompression pass 702.

Performing a variable length decoding pass 704 refers to performing variable length decoding on input data. Variable length decoded data is produced by the variable length decoding of the variable length decoding pass 704.

In one example, the variable length decoding is performed on each value of the decompressed data. In some examples, the variable length decoding is performed on at least one value of the decompressed data. In one example, the format of values of the variable length decoded data is one of: Unicode characters, numbers, binary representations of numbers. In an example, the format of values of the decompressed data is transformed into a different format to enable the variable length decoding. In an example, the format of values of the variable length decoded data is transformed into a different format to enable subsequent decoding passes.

In various examples, the variable length decoding is performed on at least two values of the decompressed data in parallel. In this way, computing time for the variable length decoding pass 704 is reduced.

In an example, the variable length decoding is byte-wise variable length decoding.

In various examples, GroupVarint Decoding is used as the variable length decoding. This allows highly efficient, parallelizable decoding. The GroupVarint technique was elaborated on above, and decoding in an example comprises using the header byte of the GroupVarint encoded data and using the value represented by the header byte to lookup a group of four offsets representing how many bytes until the start of each value, and four masks representing how many bits for each value. In one case, the group of four offsets is +1, +2, +3, +5, and the group of four masks is ff, ff, ffff, ffffff. In this case, these groups indicate that a first value represented by a byte has 8 bits, a second subsequent value represented by a subsequent byte has 8 bits, a third subsequent value beginning 2 bytes later than the first has 16 bits and 2 bytes, and a fourth subsequent value beginning 4 bytes later than the first has 24 bits and 3 bytes. Processing these bits allows the values represented by the variable length data to be reconstructed. It should be understood that the combination of offsets and masks is specific to the data encoded using GroupVarint encoding.

In some cases, variable length decoding requires additional data to the decompressed data, which is received from and respectively sent by the encoding method of FIG. 3 alongside the encoded binary image.

Thirdly, a differential decoding pass 706 is performed on the variable length decoded data produced by the variable length decoding pass 704.

Performing a differential decoding pass 706 refers to performing differential decoding on input data. Differential decoded data is produced by the differential decoding of the differential decoding pass 706.

Differential decoding comprises performing the opposite of the differential encoding method used to encode the received 700 binary image, so as to reconstruct the original values input to the differential decoding method.

It therefore comprises producing differential decoded data comprising a plurality of sequences of values, each sequence being values, in various examples all values, in the differential decoded data associated with one of: a same row and a same column, of pixels of the binary image that was encoded and received 700. Producing differential decoded data comprises determining a first sequence of values, in one example all values, in the variable length decoded data produced by the variable length decoding pass 704 and associated with one of: a first row and a first column, of pixels of the binary image encoded and received 700, using the resolution of the binary image encoded and received 700. The first sequence of values refers to all values in the variable length decoded data associated with a first row or first column of the binary image encoded and received 700. In some cases, the first sequence of values in the variable length decoded data is the same as a first sequence of values of the run-length encoded data produced by a run-length encoding pass 302 of a method which encoded the binary image encoded and received 700.

In various examples, the first sequence of values refers to all values in the variable length decoded data associated with a first row of the binary image encoded and received 700, in response to the binary image encoded and received 700 having been encoded using run-length encoding by row. In various examples, the first sequence of values refers to all values in the variable length decoded data associated with a first column of the binary image encoded and received 700, in response to the binary image encoded and received 700 having been encoded using run-length encoding by column.

This allows the determining of the first sequence of values during differential decoding as the first sequence of values sums to the number of pixels in the binary image along the respective row or column associated with the first sequence. The number of pixels along the respective row or column in some cases is determined from the resolution of the binary image, the resolution of the binary image being indicated in metadata received alongside the encoded binary image 700. In various examples, the first sequence is stored as differential decoded data.

Producing differential decoded data further comprises performing a calculation on a subsequent sequence of values, in one case all values, in the variable length decoded data associated with one of: a subsequent row and a subsequent column, of pixels of the binary image. In various examples, a subsequent row and a subsequent column are a same subsequent row and a same subsequent column respectively, the rows and columns respectively being the same for the same calculation of a subsequent row. In some cases, the calculation is performed on each subsequent sequence of values of the variable length decoded data, each subsequent sequence associated with one of: a same subsequent row and a same subsequent column, of pixels of the binary image encoded and received 700. In some examples, a subsequent sequence is subsequent to the first sequence and, in an example, immediately subsequent to a sequence that is the target of an immediately prior calculation.

The calculation on a subsequent sequence of values comprises, for a value, in an example each value, of the subsequent sequence, adding the value to a second value where the second value exists, the second value located in a second sequence of values in the variable length decoded data associated with one of: a second row and a second column, of pixels of the binary image encoded and received 700, the second row different to the subsequent row of pixels, the second column different to the subsequent column of pixels, the second value located at a position in the second sequence corresponding to a position of the value in the subsequent sequence.

In an example, a corresponding position in a sequence of values refers to having the same index in the sequence, in various examples being a position in an order of values of the sequence.

In some cases, the second sequence of values in the variable length decoded data is associated with a row or column of pixels of a binary image that is one of: immediately prior and prior, to a row or column of the pixels with which the subsequent value is associated.

As mentioned herein, a value associated with a pixel or pixels of a binary image refers to the value being a representation of the pixel or pixels of the binary image, in various examples being an encoded value or values of the pixel or pixels of the binary image.

In various examples, the second sequence of values in the variable length decoded data is associated with a row or column of pixels of a binary image that is one of: immediately after and after, a row or column of the pixels with which the subsequent value is associated. In some cases, the choice of values in the decoding method corresponds to the choice of values during encoding of the image encoded by an encoding method and received 700 by the method of FIG. 7, such that input data to each encoding pass is recovered by input data to a corresponding decoding pass.

After and prior with respect to rows or columns of pixels in the binary image correspond to differences in a row or column position of 1, 2, 3, 5, 10 or any other number of rows.

In an example, a second value existing refers to there being a value located at the position of the second value as defined. In various examples, in response to a second value not existing, the subsequent value is stored as the result of the differential decoding.

In an example, a resulting at least one output value of the calculation determined by adding a value of the subsequent sequence of values which is the target of the calculation to a second value replaces one of: the value of the subsequent sequence of values and the second value, in the variable length decoded data to produce differential decoded data.

In another example, a resulting at least one output value of the calculation determined by adding a value of the subsequent sequence of values which is the target of the calculation to a second value is stored in a location in a sequence of values that corresponds to the location of one of: the value of the subsequent sequence of values and the second value, in the variable length decoded data, to produce differential decoded data.

The start and end of each subsequent sequence of values that is the target of the calculation is determined using the resolution of the binary image. In various examples, each value of each subsequent sequence of values is decoded in turn until the sum of the decoded values is equivalent to a value indicated by the resolution of the binary image. As the decoded values represent the run-length encoded binary image, the sum of the run-lengths should equal a respective number of row or column pixels in the binary image. At this point, it is determined that a sequence of values associated with a row or column of the binary image has been decoded, and, in some cases, a further sequence associated with a row or column is decoded, until, for example, run-length encoded data corresponding to differential decoded data from the differential decoding pass 706 is produced.

In various examples, the differential decoding of the differential decoding pass 706 is performed on the variable length decoded data in parallel, for example on at least two values of the variable length decoded data by using a parallel prefix sum.

Finally, a run-length decoding pass 708 is performed on the differential decoded data produced by the differential decoding pass 706. Performing a run-length decoding pass 708 comprises performing run-length decoding on the differential decoded data to produce a binary image which is a reconstruction of the binary image encoded by an encoding method and received 700 by the method of FIG. 7.

In some cases, run-length decoding is performed on each value of the differential decoded data. In one case, run-length decoding is performed on at least two sequences of values of the differential decoded data in parallel, where the differential decoded data comprises a plurality of sequences of values, each associated with a row or column of the binary image encoded and received 700.

Run-length decoding comprises expanding at least a value, in some cases expanding each sequence of values of the differential decoded data, each sequence comprising values, in an example all values, associated with a same row or same column of the binary image. In some cases the choice of whether to expand sequences associated with a row or expand sequences associated with a column is determined based on whether run-length encoding of the binary image later received 700 was earlier performed per row or per column; the decoding technique should correspond to the encoding technique.

Expanding values in a sequence of values refers to converting each numerical value to a sequence of a same value, the same value repeating a number of times equivalent to the numerical value, where the same value changes from a first same value to a second same value that is different for each expansion of a subsequent numerical value in the sequence. In this way, run-length encoding is undone, and a binary image is reconstructed.

Illustratively, a sequence of values in differential decoded data associated with a same row of pixels in a binary image, in an example, comprises the numerical values 2,8,6. Run-length decoding this sequence results, in various examples, in 1,1,0,0,0,0,0,0,0,0,1,1,1,1,1,1. In other examples, decoding this sequence results in 0,0,1,1,1,1,1,1,1,1,0,0,0,0,0,0. In both cases, similar information is retained.

In some cases, the choice of first and second same value when expanding is predetermined. In one example, the choice of first and second same value when expanding is indicated by data received alongside the encoded binary image 700 and produced and sent by the encoding method of FIG. 3.

The passes 702-708 in various examples are performed entirely using software, and therefore do not use hardware decoding resources that, for example, are used for decoding color and/or depth images. In various examples, the passes 702-708 are implemented at least in part using hardware logic.

Alternatively, or in addition, the functionality of the encoder and/or decoder described herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

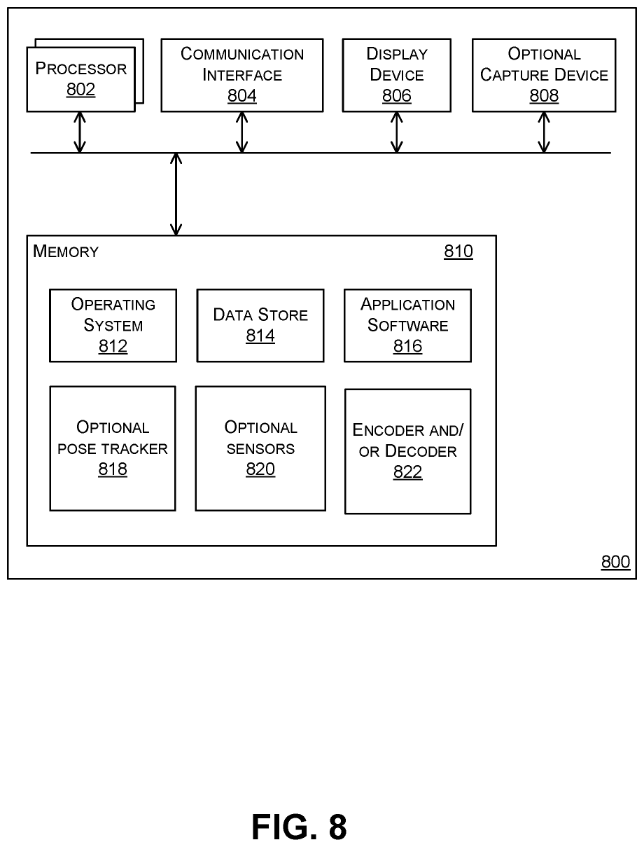

FIG. 8 illustrates various components of an exemplary computing-based device 800 which are implemented as any form of a computing and/or electronic device, and in which examples of an encoder and/or decoder are implemented.

Computing-based device 800 comprises one or more processors 802 which are microprocessors, controllers or any other suitable type of processors for processing computer executable instructions to control the operation of the device in order to encode and/or decode a binary image. In an example where the computing-based device 800 is a display device it is a head mounted display device (HMD), a smart phone, a tablet computer or other display device. In an example where the computing device 800 is a rendering device, it is a server such as a cloud server or other server, a companion computing device of a HMD, or another computing device which has greater resources than the display device. Where the computing-based device 800 is an display device it optionally comprises sensors 820 such as an inertial measurement unit IMU, an accelerometer, a gyroscope, a global positioning system. The computing-based device 800 optionally comprises a pose tracker 818 to compute a 3D position and orientation of the computing-based device. The pose tracker 718 is any conventional pose tracker such as an IMU, accelerometer, gyroscope, global positioning system or pose tracker using captured image data depicting an environment of the computing-based device 800. Data store 814 holds binary images, intermediate decoded data, intermediate encoded data, pose data, movement data, depth images, color images, cross-visibility maps, sensor data or other data. An encoder and/or decoder 822 is provided to enable the methods of any of FIG. 3 and FIG. 7.

In some examples, for example where a system on a chip architecture is used, the processors 802 include one or more fixed function blocks (also referred to as accelerators) which implement a part of the method of any of FIG. 3 and FIG. 7 in hardware (rather than software or firmware). Platform software comprising an operating system 812 or any other suitable platform software is provided at the computing-based device to enable application software 816 to be executed on the device.

The computer executable instructions are provided using any computer-readable media that is accessible by computing based device 800. Computer-readable media includes, for example, computer storage media such as memory 810 and communications media. Computer storage media, such as memory 810, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium does not include a propagating signal. Although the computer storage media (memory 810) is shown within the computing-based device 800 it will be appreciated that the storage is, in some examples, distributed or located remotely and accessed via a network or other communication link (e.g. using communication interface 804).

Alternatively or in addition to the other examples described herein, examples include any combination of the following:

Clause A: An apparatus comprising:
a processor;
a memory storing instructions that, when executed by the processor, perform a method for encoding a binary image, the method comprising:
   receiving the binary image;
   performing run-length encoding on one of: at least two rows and at least two columns, of pixels in the binary image to produce run-length encoded data;
   producing differential encoded data by, for at least one value of the run-length encoded data:
      in response to the run-length encoding having been performed on at least two rows of pixels in the binary image:
         subtracting, from the value, a second value of the run-length encoded data where a second value exists, the second value located in a first sequence of values in the run-length encoded data associated with a row of the pixels that is different to a row of the pixels with which the value is associated, and the second value located at a position in the first sequence corresponding to a position of the value in a second sequence of values in the run-length encoded data associated with a row of the pixels with which the value is associated;
   in response to the run-length encoding having been performed on at least two columns of pixels in the binary image:
      subtracting, from the value, a second value of the run-length encoded data where a second value exists, the second value located in a first sequence of values in the run-length encoded data associated with a column of the pixels that is different to a column of the pixels with which the value is associated, and the second value located at a position in the first sequence corresponding to a position of the value in a second sequence of values in the run-length encoded data associated with a column of the pixels with which the value is associated;
performing variable length encoding on the differential encoded data to produce variable length encoded data; and
applying a lossless compressor to the variable length encoded data to produce compressed data, the compressed data being an encoded binary image.

Clause B: The apparatus of Clause A, wherein:
in response to the run-length encoding having been performed on at least two rows of pixels in the binary image, the first sequence is a sequence of values in the run-length encoded data associated with a row of the pixels that is one of: immediately prior to and immediately after, a row of the pixels with which the value is associated, and
in response to the run-length encoding having been performed on at least two columns of pixels in the binary image, the first sequence is a sequence of values in the run-length encoded data associated with a column of the pixels that is one of: immediately prior to and immediately after, a column of the pixels with which the value is associated.

Clause C: The apparatus of any preceding clause, wherein performing run-length encoding on one of: at least two rows and at least two columns, of pixels in the binary image to produce run-length encoded data comprises performing run-length encoding respectively on one of: at least two rows and at least two columns, in parallel.

Clause D: The apparatus of any preceding clause, wherein producing differential encoded data comprises producing differential encoded data for at least two values of the run-length encoded data in parallel.

Clause E: The apparatus of any preceding clause, wherein performing variable-length encoding comprises performing variable-length encoding on at least two values of the differential encoded data in parallel.

Clause F: The apparatus of any preceding clause, wherein the variable length encoding is byte-wise variable length encoding.

Clause G: The apparatus of Clause F, wherein the byte-wise variable length encoding is Group Variant Encoding.

Clause H: The apparatus of any preceding clause, wherein the lossless compressor is one of: a dictionary compressor, an entropy compressor.

Clause I: The apparatus of any preceding clause, the method further comprising sending the compressed data to a device for decoding.

Clause J: The apparatus of Clause I, the method further comprising sending metadata to the device alongside the compressed data, the metadata indicating a resolution of the binary image.

Clause K: The apparatus of any preceding clause, wherein the binary image is a cutout mask, the cutout mask indicating an area of a real-world entity in an image, the cutout mask for overlaying a second image to produce a composition for displaying on a display of a head-mounted device.

Clause L: A method for encoding a binary image, the method comprising:
receiving the binary image;
performing run-length encoding on pixel data of the binary image to produce run-length encoded data;
performing differential encoding on the run-length encoded data to produce differential encoded data;
performing variable length encoding on the differential encoded data to produce variable length encoded data;
applying a lossless compressor to the variable length encoded data to produce compressed data, the compressed data being an encoded binary image.

Clause M: The method of Clause L, the method at least partially carried out using hardware logic.

Clause N: A method for decoding an encoded binary image, the method comprising:
receiving the encoded binary image, the encoded binary image comprising encoded data;
receiving data indicating a resolution of a binary image to be decoded from the encoded binary image;
applying a lossless decompressor to the encoded data to produce decompressed data;
performing variable length decoding on the decompressed data to produce variable length decoded data;
producing differential decoded data comprising a plurality of sequences of values, each sequence being values in the differential decoded data associated with one of: a same row and a same column, of pixels of the binary image, by:
   determining a first sequence of values in the variable length decoded data associated with one of: a first row and a first column, of pixels of the binary image using the resolution of the binary image;
   performing a calculation on a subsequent sequence of values in the variable length decoded data associated with one of: a subsequent row and a subsequent column, of pixels of the binary image, the calculation comprising:
      for a value of the subsequent sequence, adding the value to a second value where the second value exists, the second value located in a second sequence of values in the variable length decoded data associated with one of: a second row and a second column, of pixels of the binary image, the second row different to the subsequent row of pixels, the second column different to the subsequent column of pixels, the second value located at a position in the second sequence corresponding to a position of the value in the subsequent sequence,
   wherein a start and an end of the subsequent sequence are determined using the resolution of the binary image; and
performing run-length decoding on the differential decoded data, to produce the binary image.

Clause O: The method of Clause N, wherein the binary image is a cutout mask, and wherein the encoded binary image is an encoded cutout mask, the cutout mask indicating an area of a real-world entity in an image, the cutout mask for producing a composition for displaying on a display of a head-mounted device.

Clause P: The method of Clause O, further comprising using the cutout mask to perform at least one of: overlay a received image taken by a camera onto a received rendered image for display, overlay a received rendered image onto a received image taken by a camera for display, overlay a first image onto a second image, remove at least a portion of an image.

Clause Q: The method of any of Clauses N to P inclusive, wherein performing variable length decoding comprises performing variable length decoding on at least two values of the decompressed data in parallel.

Clause R: The method of any of Clauses N to Q inclusive, wherein performing run-length decoding comprises performing run-length decoding on at least two sequences of values of the differential decoded data in parallel.

Clause S: The method of any of Clauses N to R inclusive, wherein the variable length decoding is Group Variant Decoding.

Clause T: The method of any of Clauses N to S inclusive, the method at least partially carried out using hardware logic.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. An apparatus comprising:
a processor;
a memory storing instructions that, when executed by the processor, perform a method for encoding a binary image, the method comprising:
receiving the binary image;
performing run-length encoding on one of: at least two rows and at least two columns, of pixels in the binary image to produce run-length encoded data;
producing differential encoded data by, for at least one value of the run-length encoded data:
in response to the run-length encoding having been performed on at least two rows of pixels in the binary image:
subtracting, from the value, a second value of the run-length encoded data where a second value exists, the second value located in a first sequence of values in the run-length encoded data associated with a row of the pixels that is different to a row of the pixels with which the value is associated, and the second value located at a position in the first sequence corresponding to a position of the value in a second sequence of values in the run-length encoded data associated with a row of the pixels with which the value is associated;
in response to the run-length encoding having been performed on at least two columns of pixels in the binary image:
subtracting, from the value, a second value of the run-length encoded data where a second value exists, the second value located in a first sequence of values in the run-length encoded data associated with a column of the pixels that is different to a column of the pixels with which the value is associated, and the second value located at a position in the first sequence corresponding to a position of the value in a second sequence of values in the run-length encoded data associated with a column of the pixels with which the value is associated;
performing variable length encoding on the differential encoded data to produce variable length encoded data; and
applying a lossless compressor to the variable length encoded data to produce compressed data, the compressed data being an encoded binary image.

2. The apparatus of claim 1, wherein:
in response to the run-length encoding having been performed on at least two rows of pixels in the binary image, the first sequence is a sequence of values in the run-length encoded data associated with a row of the pixels that is one of: immediately prior to and immediately after, a row of the pixels with which the value is associated, and
in response to the run-length encoding having been performed on at least two columns of pixels in the binary image, the first sequence is a sequence of values in the run-length encoded data associated with a column of the pixels that is one of:
immediately prior to and immediately after, a column of the pixels with which the value is associated.

3. The apparatus of claim 1, wherein performing run-length encoding on one of: at least two rows and at least two columns, of pixels in the binary image to produce run-length encoded data comprises performing run-length encoding respectively on one of: at least two rows and at least two columns, in parallel.

4. The apparatus of claim 1, wherein producing differential encoded data comprises producing differential encoded data for at least two values of the run-length encoded data in parallel.

5. The apparatus of claim 1, wherein performing variable-length encoding comprises performing variable-length encoding on at least two values of the differential encoded data in parallel.

6. The apparatus of claim 1, wherein the variable length encoding is byte-wise variable length encoding.

7. The apparatus of claim 6, wherein the byte-wise variable length encoding is Group Variant Encoding.

8. The apparatus of claim 1, wherein the lossless compressor is one of: a dictionary compressor, an entropy compressor.

9. The apparatus of claim 1, the method further comprising sending the compressed data to a device for decoding.

10. The apparatus of claim 9, the method further comprising sending metadata to the device alongside the compressed data, the metadata indicating a resolution of the binary image.

11. The apparatus of claim 1, wherein the binary image is a cutout mask, the cutout mask indicating an area of a real-world entity in an image, the cutout mask for overlaying a second image to produce a composition for displaying on a display of a head-mounted device.

12. A method for encoding a binary image, the method comprising:
receiving the binary image;
performing run-length encoding on pixel data of the binary image to produce run-length encoded data;
performing differential encoding on the run-length encoded data to produce differential encoded data;
performing variable length encoding on the differential encoded data to produce variable length encoded data;
applying a lossless compressor to the variable length encoded data to produce compressed data, the compressed data being an encoded binary image.

13. The method of claim 12, the method at least partially carried out using hardware logic.

14. A method for decoding an encoded binary image, the method comprising:
receiving the encoded binary image, the encoded binary image comprising encoded data;
receiving data indicating a resolution of a binary image to be decoded from the encoded binary image;
applying a lossless decompressor to the encoded data to produce decompressed data;
performing variable length decoding on the decompressed data to produce variable length decoded data;
producing differential decoded data comprising a plurality of sequences of values, each sequence being values in the differential decoded data associated with one of:
a same row and a same column, of pixels of the binary image, by:
determining a first sequence of values in the variable length decoded data associated with one of: a first row and a first column, of pixels of the binary image using the resolution of the binary image;
performing a calculation on a subsequent sequence of values in the variable length decoded data associated with one of: a subsequent row and a subsequent column, of pixels of the binary image, the calculation comprising:
for a value of the subsequent sequence, adding the value to a second value where the second value exists, the second value located in a second sequence of values in the variable length decoded data associated with one of: a second row and a second column, of pixels of the binary image, the second row different to the subsequent row of pixels, the second column different to the subsequent column of pixels, the second value located at a position in the second sequence corresponding to a position of the value in the subsequent sequence,
wherein a start and an end of the subsequent sequence are determined using the resolution of the binary image; and
performing run-length decoding on the differential decoded data, to produce the binary image.

15. The method of claim 14, wherein the binary image is a cutout mask, and wherein the encoded binary image is an encoded cutout mask, the cutout mask indicating an area of a real-world entity in an image, the cutout mask for producing a composition for displaying on a display of a head-mounted device.

16. The method of claim 15, further comprising using the cutout mask to perform at least one of: overlay a received image taken by a camera onto a received rendered image for display, overlay a received rendered image onto a received image taken by a camera for display, overlay a first image onto a second image, remove at least a portion of an image.

17. The method of claim 14, wherein performing variable length decoding comprises performing variable length decoding on at least two values of the decompressed data in parallel.

18. The method of claim 14, wherein performing run-length decoding comprises performing run-length decoding on at least two sequences of values of the differential decoded data in parallel.

19. The method of claim 14, wherein the variable length decoding is Group Variant Decoding.

20. The method of claim 14, the method at least partially carried out using hardware logic.
